(19) United States
(12) Patent Application Publication
(10) Pub. No.: US 2009/0188377 A1
(43) Pub. Date: Jul. 30, 2009

(54) Sound Generator Apparatus

(75) Inventor: Morito MORISHIMA, Hamamatsu-shi (JP)

Correspondence Address: MORRISON & FOERSTER, LLP, 555 WEST FIFTH STREET, SUITE 3500, LOS ANGELES, CA, 90013-1024, US

(73) Assignee: Yamaha Corporation, Hamamatsu-Shi (JP)

(21) Appl. No.: 12/360,732

(22) Filed: Jan. 27, 2009

(30) Foreign Application Priority Data
Jan. 28, 2008 (JP) JP-2008-015734

(51) Int. Cl. G10H 7/00

(52) U.S. Cl. 84/603

(57) ABSTRACT

Sound generator apparatus includes an arithmetic operation section that executes a plurality of types of instructions by performing arithmetic operations using a plurality of hardware-implemented arithmetic operation elements, and a control section that reads out a program from a program memory to execute the read-out program. The plurality of types of instructions include: a first extended instruction instructing that an arithmetic operation for generating envelope data to control variation over time of a sound volume should be performed using data read out from a working memory and the arithmetic operation elements; a second extended instruction instructing that an arithmetic operation for generating phase data to control a frequency of a waveform should be performed using data read out from a working memory and the arithmetic operation elements; and a third extended instruction instructing that an arithmetic operation for generating result data should be performed using the envelope and phase data and the arithmetic operation elements.

### BACKGROUND

The present invention relates to sound generator apparatus equipped with a sound generator for electronically outputting a sound waveform.

Among the conventionally-known sound generators are FM (Frequency Modulation) sound generators which are constructed to create sound colors using a frequency modulation technique. In a basic waveform generating calculation unit employed in such FM sound generators, an envelope generator (EG) generates envelope data for controlling variation over time of a sound volume, a phase generator (PG) generates phase data for controlling a frequency of a waveform, and a waveform generation section called “operator” (OP) generates sound waveform data on the basis of the envelope data and phase data.

As the FM sound generators, there have been known ones constructed of hardware and ones constructed primarily of software; the former will hereinafter be referred to as “hardware FM sound generators” while the latter will hereinafter be referred to as “software FM sound generators”. FIG. 7 is a block diagram showing a construction of a basic slot of one example of the known hardware FM sound generators. Note that the “slot” means the abovementioned waveform generating calculation unit capable of synthesizing one sound waveform data. The hardware FM sound generator comprises a combination of a plurality of dedicated circuits of the basic slots 110. Namely, the hardware FM sound generator performs FM waveform synthesis by combining a plurality of waveform data synthesized by the plurality of basic slots 110. Each of the basic slots 110 includes an operator (OP) 120, envelope generator (EG) 130, phase generator (PG) 140 and registers 151-153. Sound data of the individual slots are stored into the registers 151-153. In the following description, each of the slots is indicated by a unique slot number in brackets. Note that the combination of basic slots 110 may be implemented by actually providing a plurality of basic slots 110, or by using one basic slot 110 on a time-divisional basis.

In the illustrated example of FIG. 7, the EG (envelope generator) 130 includes a selector 131 and an adder 132, and it generates envelope data (env[n]) on the basis of envelope controlling parameters ADSR[n] and TL[n] set in the register 151.

The PG 140 includes adders 141 and 142 and a multiplier 143, and it generates phase data (phase[n]) on the basis of sound data OP[n] set in the register 152 and frequency controlling parameters NT[n] and ML[n] set in the register 153.

The OP 120 includes an exponent (Exp) calculation section 121 for converting the envelope data env[n], generated by the EG 130, from an exponential representation into a linear representation and outputting the converted envelope data, a sine (Sin) calculation section 122 for outputting sine wave data corresponding to the phase data (phase[n]) generated by the PG 140, and a multiplier 123 for multiplying together the outputs of the above-mentioned calculation sections 121 and 122; thus, the OP 120 generates sound data (ope[n]). The Exp calculation section 121 includes an Exp ROM (Read-Only Memory), and the Sin calculation section 122 includes a Sin ROM. Hereinafter, calculations performed by the EG 130, PG 140 and OP 120 will be referred to as “slot calculations”.

In the software FM sound generators, on the other hand, the above-mentioned basic slots (arithmetic operation units) are implemented primarily by software, and a DSP (Digital Signal Processor) or CPU (Central Processing Unit) sequentially performs operations pertaining to a plurality of slots on a slot-by-slot basis. Japanese Patent Application Laid-open Publication No. 2000-221981, for example, discloses a soft FM sound generator implemented by a DSP. In the software FM sound generator, registers are mapped on a memory, and access is made to the memory on the slot-by-slot basis.

It should be convenient if the function/construction of a sound generator can be changed dynamically. For example, it will be greatly convenient if the function of a sound generator is dynamically changed so that the sound generator can be used as an apparatus having a function of a 128-sound sound generator that is capable of simultaneously generating 128 (one hundred and twenty-eight) sounds and a function of a sequencer, or as an apparatus having a function of a 32-sound sound generator that is capable of simultaneously generating 32 (thirty-two) sounds, a function of a sequencer and a function for expanding compressed audio data. However, with the hardware sound generators, it is difficult to dynamically change the function/construction. With the software sound generators, on the other hand, it is possible to dynamically change the function/construction by replacing a program; however, it is difficult to achieve a sufficiently high processing speed because the DSP or CPU has to perform a multiplicity of operations one by one using software.

### SUMMARY OF THE INVENTION

In view of the foregoing, it is an object of the present invention to provide an improved sound generator apparatus which is capable of high-speed processing and whose function can be dynamically reconstructed.

In order to accomplish the above-mentioned object, the present invention provides an improved sound generator apparatus for generating a plurality of sound waveform data, which comprises: an arithmetic operation section that includes a plurality of arithmetic operation elements each implemented by a dedicated hardware device to perform a predetermined arithmetic operation, and that, in accordance with a given instruction, performs arithmetic operations for generating one sound waveform data by use of the plurality of arithmetic operation elements; a working memory that stores, for each of the plurality of sound waveform data, a parameter to be used by the arithmetic operation section for generating the sound waveform data, intermediate data generated by the arithmetic operation section during a course of generation of the sound waveform data, and the sound waveform data generated by the arithmetic operation section; a program memory that stores a program including a plurality of program codes; and a control section that executes the program by sequentially performing code execution processing on individual ones of the plurality of program codes. In order to generate one sound waveform data or generate intermediate data corresponding to the sound waveform data and in accordance with an instruction based on the program code, the code execution processing includes reading out a parameter and data from the working memory, then supplying the read-out parameter and data to the arithmetic operation section to thereby cause the arithmetic operation section to perform arithmetic operations using the read-out parameter and data, and then writing, into the working memory, intermediate data or sound waveform data that are results of the arithmetic operations performed by the arithmetic operation section. The instruction based on the program code includes an extended instruction instructing that arithmetic operations should be performed simultaneously using at least two of the plurality of arithmetic operation elements.

In a preferred embodiment, the extended instruction includes: a first extended instruction instructing that an arithmetic operation for generating envelope data to control variation over time of a sound volume of first sound waveform data should be performed on the basis of a first parameter and first intermediate data pertaining to the first sound waveform data read out from the working memory and using at least two predetermined ones of the plurality of arithmetic operation elements; a second extended instruction instructing that an arithmetic operation for generating phase data to control a frequency of the first sound waveform data should be performed on the basis of a second parameter and second intermediate data pertaining to the first sound waveform data read out from the working memory and using at least two predetermined ones of the plurality of arithmetic operation elements; and a third extended instruction instructing that an arithmetic operation for generating the first sound waveform data should be performed on the basis of the envelope data and the phase data and using at least two predetermined ones of the plurality of arithmetic operation elements.

Because the instruction based on the program code includes an extended instruction instructing that arithmetic operations should be performed simultaneously using at least two of the plurality of arithmetic operation elements, the sound generator apparatus of the present invention can perform, in a very short time, sound-waveform-data generating arithmetic operations which the conventional software sound generators used to take a long time to perform. Namely, with the sound generator apparatus of the present invention, processing for outputting a sound waveform can be performed at significantly increased speed; for example, it is possible to generate sound data only within a time required for access to the working memory (e.g., time required for performing the code execution processing eight times in succession, i.e. eight code execution processing). Further, the function of the sound generator apparatus of the present invention can be reconstructed by replacing (i.e., changing to another program) the program code group that is to be read out by the control section.

In a preferred embodiment, in accordance with an instruction for controlling read/write on the working memory, the control section performs: a first operation for collectively reading out the first and second intermediate data and the second sound waveform data from the working memory; a second operation for collectively reading out the first and second parameters from the working memory; and a third operation for collectively writing the first intermediate data, the second intermediate data and the first sound waveform data.

Namely, according to the preferred embodiment, the first and second intermediate data and the sound waveform data are collectively read out from the working memory, the first and second parameters are collectively read out from the working memory, and the first and second intermediate data and the generated sound data are collectively written into the working memory; in other words, multi-word access is made to the working memory. Thus, it is possible to even further increase the processing speed. For example, it is possible to generate sound data only within a time required for access to the working memory (e.g., time required for performing the code execution processing three times in succession).

In a preferred embodiment, a plural number k (k is a natural number greater than one) of the arithmetic operation sections are provided, and the working memory is shared among the k arithmetic operation sections. In this case, the control section may perform any one of: a fourth operation for collectively reading out k sets of the first and second intermediate data and the second sound waveform data from the working memory; a fifth operation for collectively reading out k sets of the first and second parameters from the working memory; and a sixth operation for collectively writing k sets of the first intermediate data, the second intermediate data and the first sound waveform data. Namely, according to this preferred embodiment, k sets of the first and second intermediate data and the sound waveform data are collectively read out from the working memory, k sets of the first and second parameters are collectively read out from the working memory, and k sets of the first and second intermediate data and the sound data are collectively written into the working memory; in other words, the operations are performed in the SIMD (Single Instruction/Multiple Data) fashion. As a result, it is possible to even further increase the processing speed. For example, by setting an appropriate value as k, this preferred embodiment can achieve the same processing speed as a sound generator apparatus equipped with a hardware sound generator.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

For better understanding of the object and other features of the present invention, its preferred embodiments will be described hereinbelow in greater detail with reference to the accompanying drawings, in which:

FIG. 1 is a block diagram showing a general hardware setup of an apparatus which includes a first embodiment of a sound generator apparatus of the present invention;

FIG. 2 is a diagram showing an example operational flow of program execution processing performed in a custom DSP of the sound generator apparatus;

FIG. 3 is a conceptual diagram schematically showing an example manner in which a plurality of program codes pertaining to a slot are executed in a conventional software FM tone generator;

FIG. 4 is a conceptual diagram schematically showing an example manner in which an FM code group pertaining to an FM function section of the custom DSP is executed;

FIG. 5 is a conceptual diagram schematically showing an example manner in which resources are distributed in the custom DSP;

FIG. 6 is a conceptual diagram schematically showing an example manner in which a plurality of program codes are executed in a second embodiment of the sound generator apparatus of the present invention; and

FIG. 7 is a block diagram showing a construction of a basic slot of a hardware FM sound generator.

### DETAILED DESCRIPTION

### First Embodiment

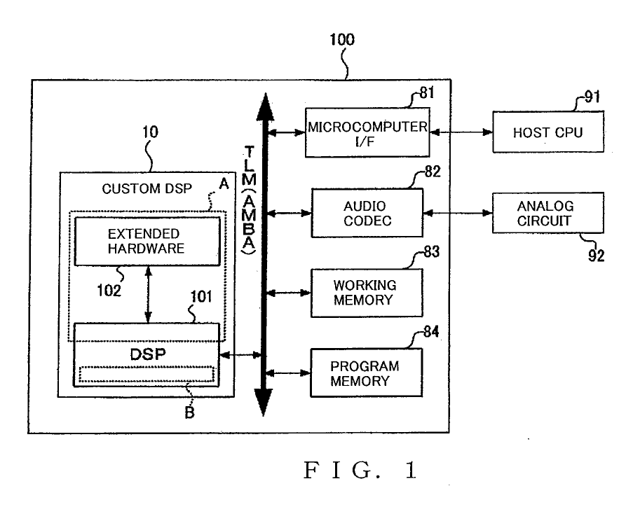

FIG. 1 is a block diagram showing a general hardware setup of an apparatus, which includes a first embodiment of a sound generator apparatus 100 of the present invention, a host CPU 91 and an analog circuit 92. The sound generator apparatus 100 includes a microcomputer interface (I/F) 81, audio codec 82, working memory 83, program memory 84 and custom DSP 10 all connected to a TLM (Transaction Level Modeling) bus, such as an AMBA (registered trademark) bus.

The host CPU 91 is connected to the microcomputer I/F 81, and the analog circuit 92 is connected to the audio codec 82. The microcomputer I/F 81 includes a serial data interface that performs SDI (Serial Data In) and SDO (Serial Data Out). The audio codec 82 includes an ADC (Analog-to-Digital Converter) and a DAC (Digital-to-Analog Converter).

The working memory 83 is, for example, a RAM (Random Access Memory), which temporarily stores first and second parameters, first and second intermediate data and sound data as will be described later. The program memory 84 is, for example, a RAM or ROM, which has prestored a plurality of programs (firmware) including a plurality of program codes. Each of the programs includes a plurality of program codes arranged in predetermined order.

The custom DSP 10 includes a DSP 101 and an expanded hardware (Custom Instruction) 102. The DSP 101 includes a plurality of arithmetic operation elements like those provided in conventional DSPs (e.g., a plurality of adders, multipliers and accumulators). Each of these arithmetic operation elements is implemented by hardware. The expanded hardware 102 includes a plurality of arithmetic operation elements not provided in conventional DSPs (e.g., selector, Exp ROM and Sin ROM). Each of these arithmetic operation elements too is implemented by hardware.

Part of the DSP 101 and the expanded hardware 102 include a plurality of arithmetic operation elements implemented by hardware and function as an arithmetic operation section A that executes a plurality of types of instructions by performing data generating arithmetic operations using at least one of the arithmetic operation elements. The plurality of types of instructions include instructions to be used for implementing a sequencer, FM sound generator, WT (Wave Table) sound generator and digital signal processing. Particularly, the instructions include first to third extended instructions. As will be later described in detail, the first to third extended instructions each instruct the arithmetic operation section A to perform data generating arithmetic operations using at least two of the arithmetic operation elements. The WT sound generator is a sound generator that records sounds of musical instruments etc. as data and reproduces the thus-recorded sound data.

Other part of the DSP 101 functions as a control section B that controls the arithmetic operation section A. Once a command is given via the microcomputer I/F 81, the control section B reads out, from the program memory 84, the program corresponding to the command and then performs program execution processing. The program execution processing executes the read-out program by sequentially performing code execution processing on individual ones of a plurality of program codes at a predetermined execution frequency, e.g. 1 sec/150 MHz. Further, in each of the code execution processing, if the program code to be executed corresponds to any one of the above-mentioned plurality of types of instructions, the control section B causes the arithmetic operation section A to execute that program code. Namely, the sound generator apparatus 100 has functions corresponding to the programs to be executed by the control section B.

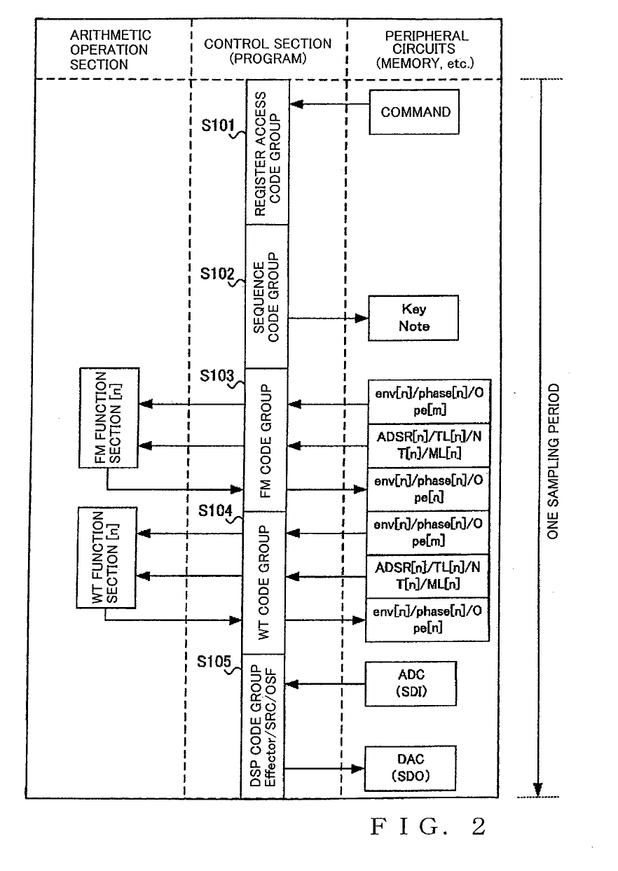

FIG. 2 is a diagram showing an example operational flow of the program execution processing in the custom DSP 10. The custom DSP 10 operates in synchronism with a sampling frequency. In the figure, there is shown an operational flow in one sampling period. In the illustrated example, the program is designed to cause the sound generator apparatus 100 to function as a high-function sound generator which has a function of a sequencer, a function of a 64-sound FM sound generator and a function of a 64-sound WT (wave Table) sound generator, and which is also capable of performing digital signal processing. The program includes, as program codes for each sampling period, a register access code group, sequence code group, FM code group, WT code group and DSP code group. Each of the code groups is a divided program that includes a plurality of program codes arranged in predetermined order. In each of the sampling periods, the control section B sequentially executes the program codes for the sampling period from the first or leading program code onward, as will be detailed below by way of example.

First, the program execution processing is performed on the register access code group in step S101. In the program execution processing, a function corresponding to a command given via the microcomputer I/F 81 is deployed in the working memory 83. More specifically, various processes, such as register mapping onto the working memory 83, data writing into the working memory 83 and transferring of sound color data and note data, are performed in step S101. Then, the program execution processing is performed on the sequence code group in step S102, in which a sequencer that turns on/off corresponding keys in accordance with the note data is realized and key notes are written into the working memory 83.

Then, the program execution processing is performed on the FM code group in step S103, in which the arithmetic operation section A functions as a plurality of FM function sections corresponding to a plurality of slots (i.e., waveform generating calculation units) of an FM sound generator. Each of the FM function sections performs slot calculations pertaining to the corresponding slot. In the figure, there is shown the FM function section [n] corresponding to the n-th slot. Details of a construction of the FM function sections and contents of the program execution processing on the FM code group will be discussed later.

Then, the program execution processing is performed on the WT code group in step S104, in which the arithmetic operation section A functions as a plurality of WT function sections corresponding to a plurality of slots of a WT sound generator. Each of the WT function sections performs slot calculations pertaining to the corresponding slot. In the figure, there is shown the WT function section [n] corresponding to the n-th slot. Construction of the WT function sections is similar to the construction of the FM function sections, and contents of the program execution processing on the WT code group are similar to the contents of the program execution processing on the FM code group.

After that, the program execution processing is performed on the DSP code group in step S105, in which digital signal processing is performed for an effecter, sampling rate converter (SRC), over-sampling filter (OSF), etc. In the illustrated example, an analog signal is input from the external analog circuit 92 via the ADC, then mixing is performed between the input signal and signals (sound data) generated by the program execution processing performed on the FM code group and WT code group, then an effecter process is performed on the mixed signal, and then the signal having been subjected to the effecter process is output to the analog circuit 92 via the over-sampling filter and DAC. The sampling rate converter (SRC) is provided for converting the sampling frequency of the signal input to the SDI to a sampling frequency of the custom DSP 10.

Upon completion of the program execution processing on the program codes for one sampling period, the control section B shifts the custom DSP 10 to a suspend mode so as to cut down power consumption until the one sampling period ends. However, in the illustrated example, the one sampling period ends simultaneously with completion of the program execution processing on the program codes, and thus, the program execution processing on the program codes for the next sampling period is started without the shift to the suspend mode being effected.

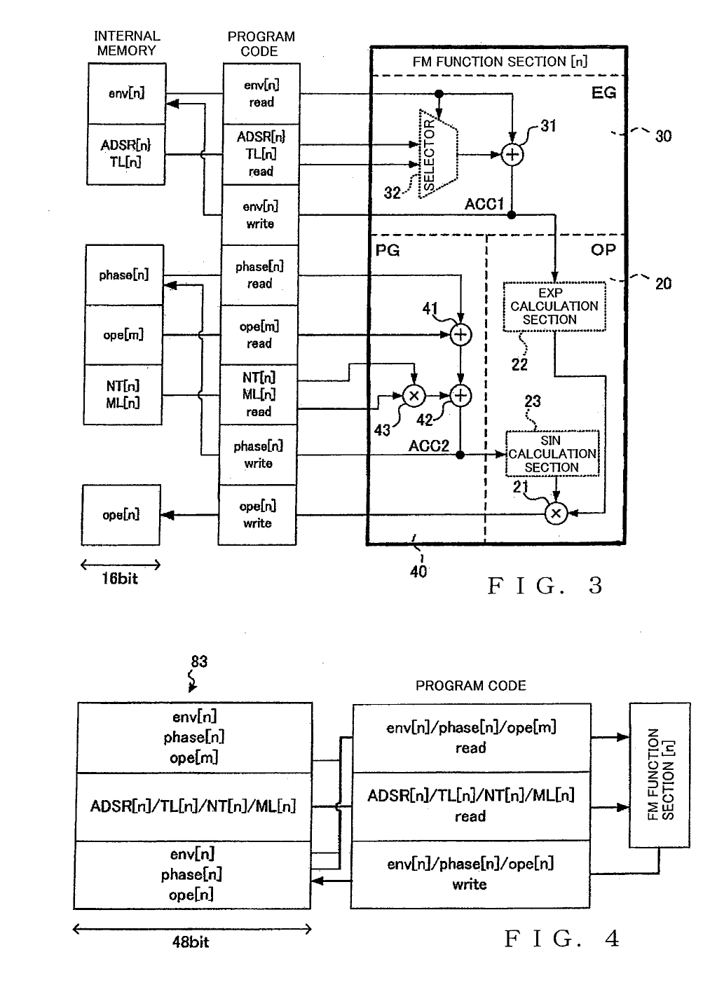

FIG. 3 is a conceptual diagram schematically showing an example manner in which a plurality of program codes pertaining to a slot [n] in a conventional software FM tone generator are executed. In the illustrated example of FIG. 3, program codes in a program code field are program codes that do not correspond to instructions instructing arithmetic operations. As shown in the figure, the conventional software FM tone generator includes a function section that corresponds to the FM function section [n]. Similarly to the FM function section [n], the function section of the conventional software FM tone generator includes an operator (OP) 20, an envelope generator (EG) 30, a phase generator (PG) 40, and accumulators ACC1 and ACC2.

The EG 30 includes an adder 31 and a selector 32. The selector 32 is supplied with first intermediate data (env[n]) read out from an internal memory corresponding to the working memory 83 and two first parameters (ADSR[n] and TL[n]) read out from the internal memory. The parameters ADSR[n] (i.e., parameters for setting an attack, decay, sustain and release of a sound) and TL[n] (i.e., parameter for setting a total level) are each constant data for allowing the function section to generate sound data (ope [n]) pertaining to the slot [n]. The first intermediate data (env[n]) is envelope data generated by the function section during the course of generation of the sound data (ope[n]); the envelope data is data for controlling variation over time of a sound volume.

Output data of the selector 32 is stored into the accumulator ACC1. The adder 31 adds together the output data stored in the accumulator ACC1 and the first intermediate data (env[n]) read out from the internal memory, to thereby generate envelope data (env[n]) that is stored into the ACC1. The envelope data (env[n]) thus stored in the accumulator ACC1 is not only written as the first intermediate data into the internal memory, but also used in the OP 20.

The PG 40 includes adders 41 and 42 and a multiplier 43. The adder 41 adds together the second intermediate data (phase[n]) read out from the internal memory and the sound data (ope[m]) read out from the internal memory. The addition result of the adder 41 is stored into the accumulator ACC1. The second intermediate data (phase[n]) is phase data generated by the function section during the course of generation of the sound data (ope[n]). the phase data is data for controlling a frequency of a waveform. The data ope[m] is sound data pertaining to another slot [n].

The multiplier 43 multiplies together two second parameters (NT[n] and ML[n]) read out from the internal memory. The second parameters NT[n] and ML[n] are each constant data for allowing the function section to generate sound data (ope [n]) pertaining to the slot [n]. The adder 42 adds together the multiplication result of the multiplier 43 and the addition result stored in the accumulator ACC1, to thereby generate phase data (phase[n]). The thus-generated phase data (phase[n]) is stored into the accumulator ACC2. The phase data thus stored in the accumulator ACC2 is not only written as second intermediate data into the internal memory, but also used in the OP 20.

The OP 20 includes a multiplier 21, an Exp (i.e., exponent) calculation section 22 and a Sin (i.e., sine wave) calculation section 23. The Exp calculation section 22 reads out the envelope data (env[n]) from the accumulator ACC1 and outputs the envelope data (env[n]) after converting the envelope data from an exponential representation to a linear representation. The Sin calculation section 23 reads out the phase data (phase[n]) from the accumulator ACC2 and outputs sine wave data corresponding to the read-out phase data. The multiplier 21 multiplies together the output data of the Exp calculation section 22 and the output data of the Sin calculation section 23, to thereby generate result data (ope[n]). The thus-generated multiplication result data (ope[n]) is stored into the accumulator ACC1. The result data (ope[n]) thus stored in the accumulator ACC1 is written into the internal memory as sound data pertaining to the slot [n].

In the conventional software FM sound generator, the selector 32, Exp calculation section 22 and Sin calculation section 23 are implemented by software. Thus, each of the selector 32, Exp calculation section 22 and Sin calculation section 23 requires dozens of steps (or execution cycles) per processing, which would make it difficult to secure a sufficiently-high processing speed.

In the instant embodiment of the invention, on the other hand, not only the adders 31, 41 and 42 and multipliers 21 and 43 but also the selector 32, Exp calculation section 22 and Sin calculation section 23 are implemented by hardware. For example, the Exp calculation section 22 is in the form of an Exp ROM, and the Sin calculation section 23 is in the form of a Sin ROM. Further, in the instant embodiment of the invention, there are provided the above-mentioned first to third extended instructions. Note that the selector 32 is not a mere selector but constructed to also perform predetermined arithmetic operation processing.

Arithmetic operation which the first extended instruction instructs the arithmetic operation section A to perform can be expressed by a mathematical expression, env[n]=EG(env[n]), ADSR[n], TL[n])=SEL(env[n]), ADSR[n], TL[n])+env[n]. Namely, the first extended instruction instructs the arithmetic operation section A to perform an arithmetic operation for generating envelope data env[n] using the first parameters (ADSR[n] and TL[n]) and first intermediate data (env[n]) read out from the working memory 83 and the hardware-implemented adder 31, selector 32 and accumulator ACC1.

Arithmetic operation which the second extended instruction instructs the arithmetic operation section A to perform can be expressed by a mathematical expression, phase[n]=PG(phase[n]), NT[n] (i.e., note number), ML[n]) (i.e., octave information)=phase[n]+ope[m]+NT[n]*ML[n]. Namely, the second extended instruction instructs the arithmetic operation section A to perform an arithmetic operation for generating phase data (phase[n]) using the second parameters (NT[n] and ML[n]), second intermediate data (phase[n]) and sound data (ope[m]) of another slot read out from the working memory 83 and the hardware-implemented adder 41, adder 42, multiplier 43 and accumulator ACC2.

Arithmetic operation which the third extended instruction instructs the arithmetic operation section A to perform can be expressed by a mathematical expression, ope[n]=OP(ACC1, ACC2)=Exp(ACC1)*Sin(ACC2). Namely, the third extended instruction instructs the arithmetic operation section A to perform an arithmetic operation for generating result data (ope[n]) using the envelope data (env(n)) stored in the accumulator ACC1, phase data (phase(n)) stored in the accumulator ACC2 and the hardware-implemented multiplier 21, Exp calculation section 22 and Sin calculation section 23.

The arithmetic operation instructed by each of the first to third extended instructions is one using at least two arithmetic operation elements. Thus, in the instant embodiment, it is possible to perform in one action a plurality of processes that had to be performed one by one in the conventional software tone generator. Further, the arithmetic operation instructed by each of the first to third extended instructions is performed using only the arithmetic operation elements implemented by hardware. Thus, with the instant embodiment, it is possible to perform slot calculations in an extremely short time (i.e., time shorter than one execution period).

Further, the program execution processing performed on the FM code group pertaining to the slot [n] of the FM sound generator includes an access process for: reading out the parameters ADSR[n] and TL[n] and first intermediate data (env[n]) from the working memory 83 before the arithmetic operation section A (FM function section [n]) is caused to execute the first extended instruction; reading out the parameters NT[n] and ML[n], second intermediate data (phase [n]) and sound data (ope[m]) from the working memory 83 before the arithmetic operation section A (FM function section [n]) is caused to execute the second extended instruction; and writing the generated envelope data (env[n]), phase data (phase [n]) and result data (ope[n]) into the working memory 83 as the first intermediate data (env[n]), second intermediate data (phase [n]) and sound data (ope[n]) pertaining to the slot [n].

The access process may be implemented in various ways. According to a preferred implementation of the access process, the control section B performs eight code execution processing in succession to thereby complete the program execution processing pertaining to one slot. More specifically, according to the preferred implementation of the access process, as shown in FIG. 3, the first intermediate data is read out in the first code execution processing (“env[n] read”) for the slot [n]; the first parameters are read out in the second code execution processing (“ADSR[n] TL[n] read”); the first extended instruction is executed by the arithmetic operation section A (FM function section [n]) during a time period from the end of the readout of the first parameters to the start of the third code execution processing (“env(n) write”); the envelope data (env[n]) generated through the execution of the first extended instruction is written as the first intermediate data in the third code execution processing; the second intermediate data is read out in the fourth code execution processing (“phase[n] read”); the sound data pertaining to another slot [m] is read out in the fifth code execution processing (“ope[m] read”); the second parameters are read out in the sixth code execution processing (“NT[n] ML[n] read”); the second extended instruction is executed by the arithmetic operation section A (FM function section [n]) during a time period from the end of the readout of the second parameters to the start of the seventh code execution processing (“phase[n] write”); the phase data (phase[n]) generated through the execution of the second extended instruction is written as the second intermediate data in the seventh code execution processing; the third extended instruction is executed by the arithmetic operation section A (FM function section [n]) during a time period from the end of the generation of the phase data to the start of the eighth code execution processing (“ope[n] write”); the result data ope[n] generated through the execution of the third extended instruction is written as the sound data pertaining to the slot [n] in the eighth code execution processing. Note that each of the extended instructions is programmed in advance in the DSP, separately from the eight-step program codes, in such a manner that the logic indicated in the OP 20, EG 30 and PG 40 of FIG. 3 can be built.

According to the aforementioned preferred implementation of the access process, the operations pertaining to each one slot of the FM sound generator can be completed in a total of eight steps (i.e., execution cycle or period×8) required for one-word access to the working memory 83. This is a great increase in the processing speed in view of the fact that the conventional software FM sound generator requires about 100 steps per processing pertaining to each one slot. However, with a view to even further increasing the processing speed, the control section B in the instant embodiment may be constructed to perform three code execution processing in succession to thereby complete the program execution processing pertaining to one slot, as will be detailed below.

FIG. 4 is a conceptual diagram schematically showing an example manner in which an FM code group pertaining to the FM function section [n] is executed. According to another preferred implementation of the access process, as shown in FIG. 4, the control section B performs for the slot [n]: a first operation for collectively reading out the first and second intermediate data and sound data of another slot [m] from the working memory 83 in the first code execution processing (“env[n]/phase[n]/ope[m] read”); a second operation for collectively reading out the first and second parameters from the working memory 83 in the second code execution processing (“ADSR[n]/TL[n]/NT[n]/ML[n] read”); a third operation for collectively writing (1) the data env[n] generated by the arithmetic operation section A (FM function section [n]) through the execution of the first extended instruction, (2) the data phase[n] generated by the arithmetic operation section A (FM function section [n]) through the execution of the second extended instruction and (3) the data ope[n] generated by the arithmetic operation section A (FM function section [n]) through the execution of the third extended instruction into the working memory 83 as the first and second intermediate data and sound data of the slot [n], respectively, in the third code execution processing (“env[n]/phase[n]/ope[n] write”) following the readout of the first and second parameters.

Namely, according to the other preferred implementation of the access process, access is made to the working memory 83, three words (i.e., 48 bits) by three words, and the operations pertaining to each one slot of the FM sound generator can be completed in a total of three steps (execution cycle or period×3) required for the three-word access (i.e., multi-word access) to the working memory 83. The foregoing description about the FM sound generator applies to the WT sound generator.

FIG. 5 is a conceptual diagram schematically showing an example manner in which resources are distributed in the custom DSP 10. In the illustrated example of FIG. 5, it is assumed that driving and sampling frequencies of the custom DSP 10 are about 150 MHz and about 48 kHz, respectively, and that the number of steps (execution cycles or periods) allocatable to each sampling period is 3,072 (i.e., about 150 MHz/about 48 kHz=3,072). Further, as shown in the figure, the sound generator apparatus 100 can be customized per desired application by replacing (i.e., changing to another program) the program to be executed by the control section B. First application is the afore-mentioned high-function sound generator, a second application is a combination of a sound generator (e.g., 32-sound FM sound generator and 32-sound WT sound generator) and compressed audio processing (e.g., reproduction of two-channel MP3 data), and a third application is a combination of a simplified sound generator (4-sound FM sound generator and sequencer) and floating-point digital signal processing.

Referring to the above-mentioned high-function sound generator, 786 steps of the 3,072 steps are allocated to the sequencer, other 786 steps allocated to a 128-sound sound generator (i.e., 64-sound FM sound generator and 64-sound WT sound generator), and the remaining 1,536 steps are allocated to digital signal processing. In order to provide the software sound generator capable of simultaneously generating 128 sounds with two slots allocated per sound, there will be required a total of about 25,600 steps because about 100 steps are required per slot (namely, about 100 steps*128 sounds*two slots=about 25,600 steps). By contrast, the sound generator apparatus 100 of the invention, where only three steps are required per slot, can simultaneously generate 128 sounds in 768 steps if two slots are allocated per sound (namely, 3 steps*128 sounds*2 slots=768 steps). In this way, the instant embodiment of the invention can realize a function that would be difficult to realize with the conventional software tone generator.

### Second Embodiment

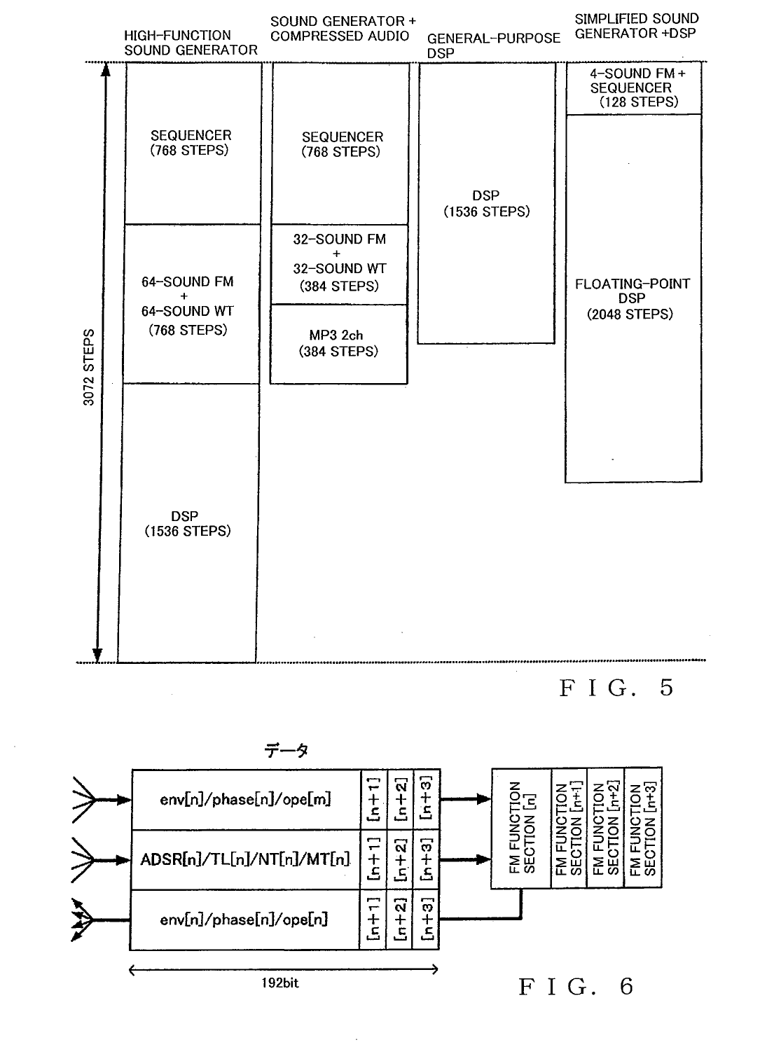

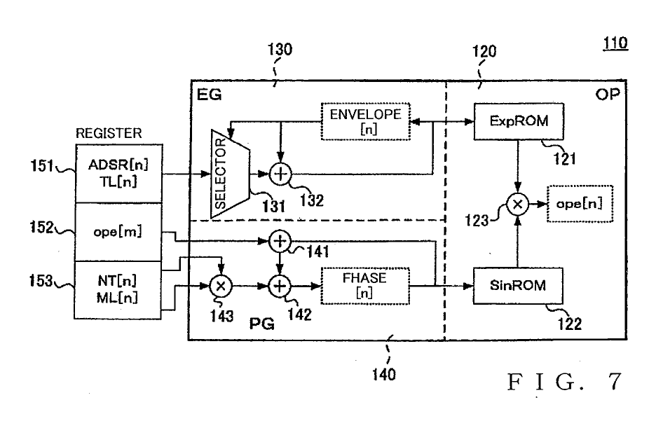

FIG. 6 is a conceptual diagram schematically showing an example manner in which a plurality of program codes are executed in a second embodiment of the sound generator apparatus of the present invention. Data shown in FIG. 6 are communicated between the working memory 83 and the control section B. The second embodiment of the sound generator apparatus includes four hardware components corresponding to the aforementioned expanded hardware 102, and four hardware components corresponding to the aforementioned arithmetic operation section A in the DSP 101. In other words, the second embodiment of the sound generator apparatus includes four arithmetic operation sections A, and one common working memory 83 is shared among these four arithmetic operation sections A.

In the second embodiment of the sound generator apparatus, various processing is performed in the SIMD fashion. More specifically, in this sound generator apparatus, the access process is performed on a four-slot-by-four-slot basis. The access process includes: a fourth operation for collectively reading out, from the working memory 83, four sets of the first and second intermediate data and sound data of another slot; a fifth operation for collectively reading out four sets of the first and second parameters from the working memory 83; and a sixth operation for collectively writing four sets of the envelope data, phase data and result data into the working memory 83 as four sets of the first and second intermediate data and sound data of the slot in question.

For example, the access process corresponding to four slots “n−n+3” includes an operation for collectively reading out env[n−n+3], phase[n−n+3] and ope[m−m+3] from the working memory 83 as the fourth operation; an operation for collectively reading out ADSR[n−n+3], TL[n−n+3], NT[n−n+3] and ML[n−n+3] from the working memory 83 as the fifth operation; and an operation for collectively writing env[n−n+3], phase[n−n+3] and ope[n−n+3] into the working memory 83 as the sixth operation.

Namely, in the second embodiment, access is made to the working memory 83, 12 words (3 words×4 slots=12 words (=192 bits)) by 12 words. Further, in the second embodiment, slot calculations for two slots are performed per step by hardware, and thus, processing for four slots can be performed in four steps; this is equivalent to a processing speed at which processing for one slot is performed per step. Namely, the second embodiment can achieve the same processing speed as the hardware FM sound generator.

### Modification

The above-described first embodiment may be modified so that, once the program execution processing is completed on the program codes for one sampling period, the custom DSP 10 performs other processing asynchronous with the sampling frequency or cycles until the one sampling period ends. Further, the above-described second embodiment may be modified so that the plural number (k) of the arithmetic operation sections A is made three or less, or five or more. In such a case, the number of the slots to be processed collectively should also be increased or decreased in accordance with the number of the arithmetic operation sections A. Further, the first and second embodiments may be modified so that access is made to the working memory 83, two or less words per slot at a time, or four or more words per slot at a time. Furthermore, the first and second embodiments may be modified so that the processing to be performed by the DSP 101 is performed by a CPU in place of the DSP 101. Such various modifications too fall within the technical scope of the present invention.

This application is based on, and claims priority to, JP PA 2008-015734 filed on 28 Jan. 2008. The disclosure of the priority application, in its entirety, including the drawings, claims, and the specification thereof, is incorporated herein by reference.

What is claimed is:

1. A sound generator apparatus for generating a plurality of sound waveform data, which comprises:
an arithmetic operation section that includes a plurality of arithmetic operation elements each implemented by a dedicated hardware device to perform a predetermined arithmetic operation, and that, in accordance with a given instruction, performs arithmetic operations for generating one sound waveform data by use of said plurality of arithmetic operation elements;
a working memory that stores, for each of the plurality of sound waveform data, a parameter to be used by said arithmetic operation section for generating the sound waveform data, intermediate data generated by said arithmetic operation section during a course of generation of the sound waveform data, and the sound waveform data generated by said arithmetic operation section;
a program memory that stores a program including a plurality of program codes; and
a control section that executes the program by sequentially performing code execution processing on individual ones of the plurality of program codes,
wherein, in order to generate one sound waveform data or generate intermediate data corresponding to the sound waveform data and in accordance with an instruction based on the program code, said code execution processing includes reading out a parameter and data from said working memory, then supplying the read-out parameter and data to said arithmetic operation section to thereby cause said arithmetic operation section to perform arithmetic operations using the read-out parameter and data, and then writing, into said working memory, intermediate data or sound waveform data that are results of the arithmetic operations performed by said arithmetic operation section, and
the instruction based on the program code includes an extended instruction instructing that arithmetic operations should be performed simultaneously using at least two of said plurality of arithmetic operation elements.

2. The sound generator apparatus as claimed in claim 1 wherein the extended instruction includes:
a first extended instruction instructing that an arithmetic operation for generating envelope data to control variation over time of a sound volume of first sound waveform data should be performed on the basis of a first parameter and first intermediate data pertaining to the first sound waveform data read out from said working memory and using at least two predetermined ones of said plurality of arithmetic operation elements;
a second extended instruction instructing that an arithmetic operation for generating phase data to control a frequency of the first sound waveform data should be performed on the basis of a second parameter and second intermediate data pertaining to the first sound waveform data read out from said working memory and using at least two predetermined ones of said plurality of arithmetic operation elements; and
a third extended instruction instructing that an arithmetic operation for generating the first sound waveform data should be performed on the basis of the envelope data and the phase data and using at least two predetermined ones of said plurality of arithmetic operation elements.

3. The sound generator apparatus as claimed in claim 2 wherein, in accordance with an instruction for controlling read/write on said working memory, said control section performs: an operation for reading out, from said working memory, a designated one or ones of the first and second parameters, the first and second intermediate data and the second sound waveform data; an operation for writing the generated envelope data into said working memory as the first intermediate data, writing the generated phase data into said working memory as the second intermediate data; and writing the generated first sound waveform data into said working memory.

4. The sound generator apparatus as claimed in claim 3 wherein, in accordance with an instruction for controlling read/write on said working memory, said control section performs at least any one of:
a first operation for collectively reading out the first and second intermediate data and the second sound waveform data from said working memory;
a second operation for collectively reading out the first and second parameters from said working memory; and
a third operation for collectively writing the first intermediate data, the second intermediate data and the first sound waveform data into said working memory.

5. The sound generator apparatus as claimed in claim 4 wherein a plural number k (k is a natural number greater than one) of the arithmetic operation sections are provided, and said working memory is shared among the k arithmetic operation sections, and
wherein said control section performs at least any one of:
a fourth operation for collectively reading out k sets of the first and second intermediate data and the second sound waveform data from said working memory;
a fifth operation for collectively reading out k sets of the first and second parameters from said working memory; and
a sixth operation for collectively writing k sets of the first intermediate data, the second intermediate data and the first sound waveform data into said working memory.
